(19) United States
(12) Patent Application Publication
(10) Pub. No.: US 2021/0134122 A1
(43) Pub. Date: May 6, 2021

(54) APPARATUS AND METHOD FOR FIXED, PROGRESSIVE, AND MYSTERY JACKPOT ROULETTE

(71) Applicant: TCS JOHN HUXLEY EUROPE LIMITED, Staffordshire (GB)

(72) Inventors: Nicole Patricia SMITH, Staffordshire (GB); Christiaan Arnoldus ELS, Staffordshire (GB)

(73) Assignee: TCS JOHN HUXLEY EUROPE LIMITED, Staffordshire (GB)

(21) Appl. No.: 17/148,028

(22) Filed: Jan. 13, 2021

Related U.S. Application Data
(63) Continuation of application No. PCT/GB2019/051813, filed on Jun. 27, 2019.

(30) Foreign Application Priority Data
Jul. 17, 2018 (GB) 1811683.0

(51) Int. Cl. G07F 17/32; G06Q 50/34

(52) U.S. Cl. CPC G07F 17/3272; G06Q 50/34; G07F 17/3241; G07F 17/3251

(57) ABSTRACT

An apparatus and a method for fixed, progressive, and mystery jackpots in a roulette game is provided, wherein the game is played by one or more players, who place value tokens on one possible event of the roulette game, the apparatus comprising a roulette game table having a physical roulette wheel, a processing unit, configured to process, transmit and receive, data, comprising memory to store data, and a controller, wherein the roulette game table is configured to determine the winning number of the physical roulette wheel of the roulette game, and wherein the controller is configured to receive the physical roulette wheel result, to randomly allocate a lucky number to each player, to store the lucky numbers and the physical roulette wheel result as winning parameters, and to determine, whether at least one player matches all winning parameters, and wherein the roulette game table is configured to indicate one player as winner of a jackpot if a player is determined by the controller to match winning parameters. Preferably the present invention improves player fun and excitement, and enhances the overall player experience.

### CROSS REFERENCE TO RELATED APPLICATIONS

This application claims priority benefit from International Application No. PCT/GB2019/051813 filed on Jun. 27, 2019, which claims priority from Great Britain Application No. 1811683.0 filed on Jul. 17, 2018, each of which is incorporated herein by reference in its entirety.

### FIELD OF THE INVENTION

The present invention relates generally to casino and casino-like table games and more particularly to providing fixed prize, progressive, and mystery jackpot prizes using physical and virtual random number generators and other probabilities for a roulette game.

### BACKGROUND OF THE INVENTION

The following discussion of the prior art is intended to facilitate an understanding of the invention and to enable the advantages of it to be more fully understood. It should be appreciated, however, that any reference to prior art throughout the specification should not be construed as an express or implied admission that such prior art is widely known or forms part of common general knowledge in the field.

It is now common for gaming establishments to offer side bets on casino table games. During the course of play of a roulette casino table game, players are provided the option of entering an auxiliary game by placing a side wager. If in the course of the round or game the event they have betted on happens, the player receives a prize, where the size of the prize is likely depending on the initial side bet. A jackpot prize is also known. Thereby a portion of the side wager accumulates in a prize pool which is won when a participating player receives a predetermined game outcome in the roulette game. This type of side wager and jackpot are known as the “event based progressive” jackpot because the jackpot accumulates as more players elect to make a side wager and because it is won depending on particular events occurring in the roulette game.

Depending on the number of gaming tables contributing to the prize pool and the game configuration, these prize pools can quickly grow to many times the base side wager. The attraction of these games is the chance to win a significant prize. Different configurations can be setup to award different percentages of the prize pool however the games are common in that a predetermined game outcome is awarded a percentage of the prize pool.

One method of providing jackpots and bonus prizes on table games is the random progressive type jackpot auxiliary game which commonly involves an event generated by a Random Number Generator (“RNG”) which is associated in some way with the underlying casino game. As an example, a display can show a randomly generated lucky card during the sequence of play of an underlying base game. If the random card is matched by the same card in a player's hand, then that player is awarded a prize. Such a method is described in U.S. Pat. No. 5,743,800.

One problem with this game is that it can be difficult to expand the side game across different types of table games because the chance of winning the jackpot can depend upon fixed odds in the roulette game.

WO 2012/100286 is a linked progressive jackpot system intended for use with dealer operated table games. Tables can participate in multiple jackpots and multiple tables can be configured to participate in the same jackpots. Both standard and mystery progressive jackpots are supported by the system. Players participate in progressive jackpots by making a side bet. A percentage of each side bet contributes to the jackpots the table is participating in. Supernova jackpots when won are awarded to participating table players.

Roulette games have known, fixed probabilities of results. To offer progressive jackpot prizes of similar sizes to other games, the hit probabilities must be significantly lower than those of a standard roulette game.

It is an object of the present invention to overcome or substantially ameliorate one or more of the deficiencies of the prior art, or at least to provide a useful alternative. The present invention also preferably aims to improve player satisfaction, provide more excitement, and enhance the overall player experience.

### SUMMARY OF THE INVENTION

Accordingly, the invention provides a method for fixed, progressive, and mystery jackpot roulette, an apparatus for fixed, progressive, and mystery jackpot roulette, and a computer program product for fixed, progressive, and mystery jackpot roulette, as defined in the independent claims.

Unless the context clearly requires otherwise, throughout the description and the claims, the words “comprise”, “comprising”, and the like are intended to be construed in an inclusive sense as opposed to an exclusive or exhaustive sense; that is to say, in the sense of “including, but not limited to”.

### BRIEF DESCRIPTION OF THE DRAWINGS

The accompanying drawings, which are incorporated in and constitute a part of the specification, illustrate embodiments of the invention and together with the detailed description herein, serve to explain the principles of the invention. It is emphasized that, in accordance with the standard practice in the industry, various features are not drawn to scale. In fact, the dimensions of the various features may be arbitrarily increased or reduced for clarity of discussion. The drawings are only for purposes of illustrating preferred embodiments and are not to be construed as limiting the invention.

FIG. 1 is an exemplary display indicating game information and jackpot information in accordance with an aspect of the present invention;

FIG. 2 is another exemplary display indicating game information and jackpot information in accordance with an aspect of the present invention.

### DETAILED DESCRIPTION

The invention provides a method for playing an auxiliary progressive jackpot game associated with a base, live casino roulette table game. The invention extends to an apparatus for administering the auxiliary game and notifying players of game occurrences including jackpot winners.

The inventive principle can also be used on an automated roulette game, where the dealer controls the spin in the sense that he triggers the beginning of a new round with an action like pushing a button, pulling a lever or a similar activity.

The inventive principle can also be used on a fully automated roulette game, without a dealer, where the game is started by a controller after a fixed time, or after all participating players have placed bets.

The roulette game can also be played in a virtual mode, where the players are not in the same location but are logged in via a computer, handheld, mobile phone or other terminal to place their bets.

Without the intention to limit the invention to this one example, in the following the description will refer to an exemplary embodiment, which is described using the live roulette game.

The auxiliary game is designed to be played as a supplementary betting game in conjunction with the base, live casino roulette table game. The term “roulette table game” used herein is used to distinguish games of chance that are played by live players and administered by one or more live dealers such as a croupier, wherein the players and dealers are in close proximity to allow physical interaction. The term does not include games played solely on a mechanical and/or electronic device like a video slot machine, or internet and online games of chance. Roulette games usually include defined passages of play known as “spins” which break play into discrete portions.

The general method of play is as follows—at predetermined periods during the roulette table game, the roulette game players are provided the option of participating in the auxiliary game. The option is normally provided during the initial stages of each hand or round and normally only once per hand or round. Players electing to participate in the auxiliary game register their side wager with side wager registration means. The side wager corresponds to a predetermined value, and a predetermined portion of the wagered value is allocated towards at least one progressive jackpot prize pool. Each side wager increments the jackpot by the predetermined portion thereby increasing the size of the jackpot. Another house portion of each side wager may be directed toward the establishment (known as the house), while another establishment portion is often used to establish the jackpot or jackpots at an initial level following a win pay-out or when initiating the jackpot system.

The invention proposes a method of selecting a winner from the auxiliary game participating players which is randomly generated and independent of the roulette table game. This type of game is referred to as a mystery progressive type jackpot auxiliary game. In winning comparison to an event-based progressive jackpot, and even the random progressive type jackpot auxiliary game, the players are not directly involved in the identification of whether they have won. Accordingly, whether the player has won the jackpot prize may be kept secret from the players and revealed at a time and in a manner to create maximum suspense and effect. In addition, because the event is not based only on the roulette game probabilities, the same jackpot pool may be configured across multiple roulette games or different types of roulette games.

One method of selecting a winner proposed by the invention is to use a Random Number Generator (“RNG”) to randomly determine the winning event. For instance, a RNG is used to select a mystery win value which is kept secret and stored. Preferably the mystery win value is selected within a predetermined range limited by at least an upper boundary but more preferably limited by upper and lower boundaries. The jackpot prize is initiated at the lower boundary and incremented sequentially by a predetermined portion of each side wager made. The jackpot is won by the player whose side wager increments the prize pool to equal or exceed the mystery win value. Alternatively, the jackpot may initiate at the upper limit and the jackpot prize incremented downwardly towards the lower limit. This type of jackpot maybe known as a mystery regressive rather than mystery progressive however the general concept is the same and the term “progressive” is intended as applying to either method or a combination of both.

Alternatively, the winner can be determined as follows: after the placement of bets for the game have been locked, either after the result of each game is known or some other time while the game is running, an RNG is used to simply calculate a value of “winner” and “no winner” for each player. Thereby more than one player can win a prize in the amount of the jackpot or an equal share thereof such that the total of prizes equals the jackpot. In this scenario the probability of winning is proportional to the upper limit, so the higher the progressive value, the more likely it will be triggered. By using this method, a mystery win value is not required and thus no extra security is required to protect it.

One exemplary implementation of the invention will now be described in detail in which an auxiliary game is offered comprising a mystery progressive jackpot. As mentioned before, the jackpot could also be a fixed jackpot.

Commonly the base roulette table game will be played at a roulette gaming table including a dealer station for accommodating at least one dealer or croupier and a plurality of player stations for accommodating a plurality of players.

In the context of the present invention, the term “gaming” will be understood by the skilled addressee to mean “gambling”.

The apparatus includes a roulette table for playing a roulette casino game including a dealer station and a plurality of player positions. The dealer station includes equipment required for playing the roulette table game. In this embodiment of the invention, betting chips or tokens are used as a table currency for wagering bets. As such, the dealer station also includes a betting token tray and a plurality of betting chips. The betting chips may correspond to and be redeemable for predetermined values including but not necessarily limited to currency values. Different types of chips may also correspond to different set amounts each type of chip readily distinguishable from one another. A dealer's interface console is provided for exchanging information between the dealer and various components of the table while a jackpot display is provided for displaying information regarding the jackpot status to the players.

Each player position includes a corresponding players side wager area or sensor situated adjacent a respective player's position.

The various components of the table are interfaced with a game computer for administering the game and components. In this embodiment the game computer is connected to the components via a table network and includes a table processing unit and a server. In this embodiment, the server is a remotely located central server connected via a wider casino network to the table processing unit or located in or near the table connected via a dedicated network to the table processing unit. Other game tables may also be connected to the casino network and central server to allow multiple tables to contribute toward the same jackpot pool. In some forms of the invention, the table processing unit and central server are integrated and may be situated on the table network, or remotely positioned on the casino.

Where required, both the table processing unit and sever include respective microprocessors for processing data, and memory devices for storing data as is known in the art along with appropriate data input and output transfer mechanisms.

In this embodiment of the invention, each player's console includes an integrated wager registration device to allow players to register a side wager, and a player's indicator. The player's consoles may be mounted within a cut out in the table. From the players perspective, only an upper surface of the console can be seen in the form of a disc, generally flush with the table surface. In this way the console is unobtrusive and does not restrict movement of game components such as value tokens yet may be easily observed and accessed by the respective player, the dealer and the other players at the table.

Each game table has a physical roulette wheel, which may transmit game results and game states to the server. Each player can place bets according to common roulette rules on the roulette table with chips. Each chip usually represents a certain amount of currency. Usually the chip can be traded for local currency at the casino. If a player runs out of chips, additional currency can be traded. If players leave the casino, they can redeem the remaining chips, which might be more than they originally traded if they won, for currency again. The currency transactions might be cashless, other valuables might be used, or in collaboration with a hotel or similar facility, the hotel's account of the guest may be charged.

The chips for different players may have different colours. Thereby the dealer can immediately identify the winning players according to their bets on the table.

The number of available chip colours can vary, and the system can be configured to reflect the number of available chip colours.

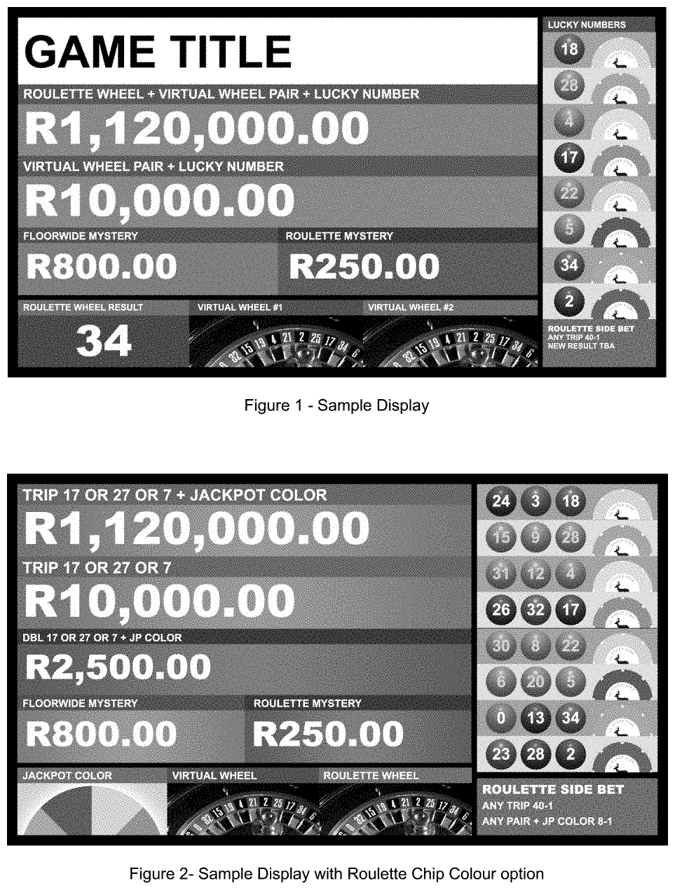

A display as exemplary depicted in FIG. 1 or FIG. 2 shows jackpot values, game results and other information.

The display can show one or more of the following: the current value of one or more progressive jackpots, the current value of optional mystery jackpots, roulette chip colours for the table that corresponds to the display, a lucky roulette chip colour indicator, one or more virtual roulette wheel results, the result from the physical roulette wheel, game title and jackpot names, and one or more lucky numbers allocated to each roulette chip colour.

The game title and the jackpot names can be changed either by the dealer station and/or the server. The one or more lucky numbers allocated to each roulette chip colour, are randomly allocated each game. If a certain roulette chip colour is not placed on a side bet sensor, the lucky number can still be allocated and displayed but can be greyed out to indicate that no side bet has been placed by the player of that chip colour.

The dealer station comprises an input device, on which the dealer or supervisor can enter relevant game information, such as game results, confirm jackpot awards, etc. Information like the game results can also be transmitted by the physical roulette wheel, as mentioned above.

The roulette table further can comprise bet sensors to detect side bets placed by players. These sensors may be embedded into the table and light up in different colours and patterns depending on the current state of the game, such as chip placed, game locked at no more bets, player awarded jackpot, etc. Other indications are possible, depending on the configuration of the table. The roulette table can also be configured to allow the dealer to input the player position and the side bets of the players. Thereby, for example, a defunct sensor can be compensated.

The roulette table may comprise one bet sensor for each roulette chip colour that is active in the game. Each of these bet sensors is allocated to one player position.

The roulette game table may comprise a processing unit, that is capable of interfacing with the display, sensors and dealer input device. The processing unit may be secured by a security dongle or similar to prevent unlicensed operation of the system. Biometric security, password or PIN code, or any kind of other item that can be detected by the table can be used to unlock the processing unit, e.g. a Bluetooth device, a NFC device, a RFID device, a wearable like a ring or a watch, or a magnetic device. Other items, codes or visual items, like a QR or barcode, or an access card, can be used to identify a valid operator. The processing unit may be in communication with the server to determine validity of an operator.

The server collates game turnover and calculate jackpot values, create reports, etc.

The display can be configured to be driven by the processing unit or the server.

During play of the base roulette game, each base game player is provided an individual player station at the roulette table. It is only possible to include as many players at the table as there are player's stations. However, it is not necessary that each and every player's station is occupied for the game to progress. Furthermore, while the term “player” generally refers to an individual, it is also used herein to refer to a “team” comprising two or more individuals playing the same game collectively.

Prior to commencing the roulette game, a period of time or “betting phase” is provided to allow players to place wagers on both the base roulette game and the auxiliary game or games should they choose. The betting phase begins when the dealer keys an initiating command into the table controller with the dealer's console. Initiating the betting phase clears the table controller of any residual betting information and sets the players' indicators to provide a visual cue to indicate the betting phase is in progress.

Each of the players' indicators can be programmed to display particular static or dynamic patterns. Each of the patterns corresponds to a particular state of the indicator and/or phase of the game. The indicator can provide distinct patterns for the different phases of the game. Exemplary, these phases can include: “Betting Phase/No Side Wager Registered”, “Betting Phase/Side Wager Registered”, “Bets Locked/No Side Wager Confirmed”, “Bets Locked/Side Wager Confirmed” or similar states or phases.

While in some systems, the players' indicators may be capable of providing an explicit visual cue that the system is ready to receive bets, in this system, the players' indicators simply show a predetermined “Betting Phase/No Side Wager Registered” pattern. Initially, if unfamiliar with the system, the players may not immediately perceive the accepting bets pattern as a cue that bets may be placed. Consequently, the cue from the indicators may be supplemented by verbal advice from the dealer and/or the more explicit visual cues on the jackpot display. With experience however, the players, once accustomed to the system will recognise particular patters displayed by the players' indicators as indicative of certain phases of the game.

In order to participate in an auxiliary game or games, the players can register a side wager by placing a betting chip or token over their respective player's console. In doing so, the corresponding colour sensor detects the presence of the chip or token and can in response thereto switch the player's indicator to a corresponding state, e.g. “Betting Phase/Side Wager Registered” which can be distinct from the previous state. This provides a visual indication that a side wager has been placed at a particular player's console by a respective player. The player and dealer can thus visually confirm that the system has acknowledged placement of a side wager. In addition, the dealer can easily scan the table and recognise which players have registered side bets and confirm that the player has used the appropriate betting chip.

If a player then removes the token from the player's console during the betting phase having decided not to make a side wager after all, the indicator returns to the previous state, e.g. “Betting Phase/No Side Wager Registered”. Provided the betting phase is still in progress, the player may change their bet as many times as they like.

After a suitable period of time, the dealer ends the betting phase by keying an appropriate command into the table controller via the dealer's console. Preferably the players are forewarned by the dealer and/or by the system before the betting phase ends to enable them to check their side wagers and make any final adjustments. Furthermore, the dealer visually confirms that all the side wagers have been made appropriately.

In most cases the side bet is a fixed value and as such the betting chips used to register a side bet will be visually identical and readily identifiable by the dealer. In this regard the same betting chips that are used in the base game may also be used to register the side bet. While the betting chips may represent a variety of values, chips of different values are normally visually distinct. Most often, chips of the same value will appear more or less identical having the same marking. Thus, the side bet entry amount will be set at a value corresponding to one of the chip values such that a particular betting chip may be used to indicate participation in the side game.

In order to aid visual identification that the correct betting chip has been used, the players indicator may be configured to display a pattern visually coded to the chip before and/or after the chip is detected. This way if a chip of the wrong amount is used to register a side bet, it may be more easily visual identified by the dealer as being incorrect. It is noted that “visually coded” may mean the same, similar or a contrasting colour and/or a pattern which matches or complements the pattern on the chip.

However, in some embodiments, the system may allow for side bets of variable values. In one implementation of variable amount side betting, the player must indicate to the dealer the value of the intended side bet. The dealer will then record, via the dealer input panel the value of the side bet the player would like to make. Of course, allowing variable amount side wagers places a greater burden on the dealer to determine that the correct betting chip is used and matches the intended side wager as recorded. Accordingly, it is preferable that the value of the side bet correspond to a particular chip value, thereby limiting variable side wagers to those values corresponding to the values of available chips. Again, as the value of each player's side bet is entered into the system, the system may adjust the pattern displayed on each players' indicator to visually correspond to the particular chip value used by each player. Thus, each player may have an indicator pattern and/or colour which is coded to the chip pattern and/or colour of a chip value corresponding to the intended side bet value as recorded by the system.

When the dealer ends the betting phase, the table controller instructs the player indicators to change the pattern displayed on each indicator from the betting phase patterns to the bets locked patterns. At the change of phase, the state of the token acceptors cannot be changed by removal or placement of a token. The indicators having a side wager confirmed will show a distinct state, e.g. “Bets Locked/Side Wager Confirmed” pattern while where no side wager has been made, the indicators may show a different pattern, e.g. “Bets Locked/No Side Wager Confirmed”. Again, the indicators can provide a clear visual signal of which players are participating in the auxiliary game. At this stage the wagered betting tokens used by the players to indicate side wagers may be collected from the token acceptors by the dealer and returned to the house.

In addition, once the bets are locked, based on the signal from each sensor, the table controller compiles a table game log of which players have made a side wager indexed by their location at the table. For instance, for players that have made side wagers, the controller compiles corresponding references in a table game log including a game reference number and table number and sends the log to the central sever over the network. This way, each side wager can be traced back to the table and player position. If bets of different amounts have been recorded, this information is also passed to the server.

To determine the increments to each progressive jackpot, the central server or the processing unit processes the table game log by allocating the predetermined portions of each referenced wager to the progressive jackpot total consecutively.

In general, if only one table is participating at a game, the processing unit can take control of the game and the determination of the winners. If more tables participate, a server can coordinate the input and outputs, but one table's processing unit can also be determined to take the role of the server for the game. Additional displays to inform players not sitting at the table can also be provided with the information of the game by the server or a processing unit. Furthermore, in certain configurations, off-table players, e.g. players sitting at a bar, can be allowed to place bets for the game as well.

The game is controlled by a controller. The processing unit of a table or the server can act as a controller. The processing unit of a single table can act as controller if only one table is participating in the game. The processing unit of one selected table out of multiple tables can act as controller, if more than one table participate in the game.

The method for determining whether one or more players have won any of the jackpots are detailed in the following.

The controller randomly allocates one or more lucky numbers to each participating player's roulette chip colour. Alternatively, a lucky number can be allocated for all possible players' roulette chip colours, irrespective or whether an actual player is participating in the game or not. Alternatively, a lucky number is only allocated to the players' roulette chip colours who have registered a side bet.

The lucky numbers are randomly selected out of a range of numbers available on the physical roulette wheel, i.e. the possible results of the physical roulette wheel are the set of elements that the lucky numbers are randomly selected from.

The lucky numbers for certain players' roulette chip colours can be greyed out, for example, if one or more player stations are not occupied, i.e. some roulette chip colours are not participating in the game, or if a player has not registered a side bet.

Further random events can be generated by the controller. Examples of such further random events are detailed in the following.

Random winning numbers, i.e. virtual results, for one or more virtual roulette wheels can be generated. These virtual results can be displayed on the display.

Out of a predetermined set of roulette chip colours, e.g. all colours, colours not used in the game, colours used in the game, colours not used for a side bet, or colours used for a side bet, one or more roulette chip colours are determined randomly. Other sets of roulette chip colours to pick one or more from can also be used. Effectively, one player is randomly selected by determining their chip's colour.

Finally, based on a selection of the above data, i.e. lucky numbers, virtual roulette wheel results, randomly determined chip colours, and based on the physical roulette wheel result, progressive jackpot prizes are determined and awarded to eligible players.

The progressive jackpot prizes are determined, by combining probabilities of different random events to consequently offer several separate progressive jackpot prizes. As mentioned before, the jackpot could also be a fixed jackpot.

The following assumes a single 0 roulette wheel, which has numbers 0 to 36 (i.e. 37 numbers). Consequently, the odds of a single number result are 1 in 37.

Examples of jackpots are detailed on the exemplary basis of the sample display in FIG. 1.

The top jackpot indicated therein is awarded for a combination of a physical wheel result, a first virtual wheel result, a second virtual wheel result, and a lucky number. Since, by betting on one number, a player has a chance of 1 to 37 to bet on the right number, and since the lucky numbers are also selected from the range of a roulette wheel, as detailed above, the odds of a player winning the top jackpot are 1 in (37 to the power of 4), i.e. 1 in 1,874,161.

Similar calculations apply to the other possible combinations of random results.

If a player has won a jackpot, the controller begins a predetermined routine of notifying the players and the dealer of the winner or winners. This may include a sequence of illuminating the player indicators to indicate that a side wager, taken at the table, has won the jackpot prize. This sequence is designed to build suspense and excitement in the players at the table without initially notifying them of the actual winner. The sequence may take any one of various forms including but not limited to the following.

“round robin” illumination, where each player's console is briefly illuminated in turn, with the illuminated player's console going in either a clockwise or counter-clockwise direction around the table.

“swing” illumination, where each player's console is briefly illuminated in turn with the direction of illumination reversing each time the first or last player position is reached.

“random” illumination, where random player's consoles briefly illuminate with no apparent pattern.

The illumination sequence may add further suspense and excitement to the players by slowing down and/or speeding up during the course of the sequencing, and/or illuminating each player's console in various different colours, and/or displaying different effects within each player's console such as spinning, pulsating, blinking, and so on.

At the conclusion of the sequence, it will be obvious which player is the winner of the jackpot due to the fact that the winning player's indicator will display a pattern unique from the other players' indicators. For instance, the winning player's indicator may stay illuminated and/or otherwise showing a unique pattern (such as blinking, spinning, pulsating, and so on) that clearly differentiates the end phase from the sequencing phase and from the other non-winning players' indictors.

The winning sequence may incorporate the illuminating spots for player positions for which no players are participating in the optional wager. Obviously, these non-played positions cannot be winners and where the winning sequence includes these non-played positions, it cannot end on such a position. However, their inclusion in the sequences adds to the visual impact of the light show.

The jackpot display may also be used to supplement or replace the winning sequence both to initially indicate that there has been a winner, and subsequently to also indicate the player that has won. Finally, the dealer will pay the winning player in chips, tokens or by issuing a voucher for redemption.

If no player has won a particular jackpot, the jackpot prize can be increased based on a fixed amount, a random amount, or by an amount determined by the game, e.g. the amount of all side bets added up.

While the above example has been described with reference to one table, the invention extends to implementations wherein multiple live gaming tables are connected to contribute to a single jackpot pool. As such the controller processes the side wagers from each participating table. In this way, the jackpot turnover is increased, and jackpots accrue more rapidly than if limited to one table. Advantageously, prizes may be larger and/or be won more regularly depending on the predetermined jackpot parameters.

Other principles of jackpot gaming and other modes or methods of side betting can be applied to the game. Some applicable modes or methods, and principles are laid out in WO 2012/100286.

The presented method, apparatus and computer program product allows for game result probabilities lower than standard roulette games and consequently large progressive jackpot prizes can be offered. Different available probabilities can be combined to allow a wide range of progressive jackpot prizes.

It will be appreciated that the present invention provides for a secure means of enrolling players in a table wide jackpot system accepting and recording player wagers, communicating to the players the various stages of the game including winnings. The system and method are readily up scalable to multiple tables and may be applied across different games of chance.

Unless specifically stated otherwise, as apparent from the following discussions, it is appreciated that throughout the specification discussions utilizing terms such as “processing,” “computing,” “calculating,” “determining”, analysing” or the like, refer to the action and/or processes of a computer or computing system, or similar electronic computing component, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, a touch screen entry unit and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the data storage device such as hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fibre optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; a carrier wave bearing a propagated signal detectable by at least one processor of the one or more processors and representing the set of instructions a propagated signal and representing the set of instructions; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method for jackpots in a roulette game, wherein the game is played by one or more players, who place value tokens on one possible event of the roulette game, the method comprising:
collecting, by a controller, winning parameters, comprising
determining the winning number of the physical roulette wheel of the roulette game; and
randomly allocate a lucky number to each player;
determining, by the controller, whether at least one player matches all winning parameters; and
if a player is determined to match all winning parameters, indicating this player as winner of a jackpot.

2. The method of claim 1,
wherein collecting winning parameters further comprises one or more of:
randomly determining the winning number of one or more virtual roulette wheels; and
randomly determining one of the players; and
wherein the players also place value tokens on possible events of the one or more virtual roulette wheels.

3. The method of claim 1, wherein if no player is determined to match all winning parameters, indicating no player as winner, and increasing the value of the jackpot based on one of:
a fixed amount, a random amount, or by an amount determined by the game.

4. The method of claim 1, wherein determining the winning number of the physical roulette wheel comprises,
receiving, by the controller, the winning number by a sensor of the roulette wheel, or
receiving, by the controller, the winning number as an input by a game operator.

5. The method of claim 1, wherein the method further comprises detecting, by sensors, the value tokens placed by the players, wherein preferably each player is using value tokens of one colour allocated to him.

6. The method of claim 1, wherein the jackpot is a fixed jackpot, a progressive jackpot, or a mystery jackpot.

7. An apparatus for jackpots in a roulette game, wherein the game is played by one or more players, who place value tokens on one possible event of the roulette game, the apparatus comprising:
a roulette game table having a physical roulette wheel;
a processing unit, configured to process, transmit and receive, data, comprising memory to store data, and a controller;
wherein the roulette game table is configured to determine the winning number of the physical roulette wheel of the roulette game; and
wherein the controller is configured
to receive the physical roulette wheel result;
to randomly allocate a lucky number to each player;
to store the lucky numbers and the physical roulette wheel result as winning parameters; and
to determine, whether at least one player matches all winning parameters; and
wherein the roulette game table is configured to indicate one player as winner of a jackpot if a player is determined by the controller to match all winning parameters.

8. The apparatus of claim 7, wherein the controller is further configured:
randomly determine the winning number of one or more virtual roulette wheels;
randomly determine one of the players; and
store the determined winning number of one or more virtual roulette wheels and the determined player as additional winning parameters; and
wherein the players also place value tokens on possible events of the one or more virtual roulette wheels.

9. The apparatus of claim 7, wherein if no player is determined to match all winning parameters, the controller is further configured to indicate no player as winner, and to increase the value of the jackpot based on one of:
a fixed amount, a random amount, or by an amount determined by the game.

10. The apparatus of claim 7, wherein the roulette game table further comprises sensors to determine the winning number of the physical roulette wheel, and the controller receives the physical roulette wheel result from the sensors; or wherein the roulette game table further comprises an input device, and the controller receives the physical roulette wheel result from the input device, where an operator inputs the result.

11. The apparatus of claim 7, wherein the roulette game table further comprises token sensors configured to detect the value tokens placed by the players, wherein preferably each player is using value tokens of one colour allocated to him.

12. The apparatus of claim 7, wherein the processing unit is configured to be operable only after unlocking a security device by means of one of the following:
a security dongle, biometric security, a password, a PIN code, a Bluetooth device, a NFC device, a RFID device, a wearable, a magnetic device, a QR code, a barcode, or an access card;
wherein the processing unit may be configured to receive authentication data from a connected server.

13. The apparatus of claim 7, wherein the apparatus further comprises a display to indicate game information and jackpot information; and/or
indication devices to indicate a winning player.

14. The apparatus of claim 7, wherein the jackpot is a fixed jackpot, a progressive jackpot, or a mystery jackpot.

15. A system for jackpots in a roulette game, wherein one or more apparatuses of claim 7 are connected and participate in one game together,
wherein the function of the controller is performed by
one processing unit of one roulette game table, which is determined automatically or manually before the game, or
by a server to which all processing units of all roulette game tables are connected.

16. A computer program product including a program for a processing device, comprising software code portions for performing the steps of claim 1, wherein the program is run on the processing device.

17. The computer program product of claim 16, wherein the computer program product comprises a computer-readable medium on which the software code portions are stored, wherein the program is directly loadable into an internal memory of the processing device.
